(19) United States
(12) Patent Application Publication
(10) Pub. No.: US 2016/0091825 A1
(43) Pub. Date: Mar. 31, 2016

(54) POWDER CONTAINER DEVICE

(71) Applicant: FUJI XEROX CO., LTD., Tokyo (JP)

(72) Inventors: Shota OBA, Kanagawa (JP); Shigeru INABA, Kanagawa (JP); Norihiro TAMAZAWA, Kanagawa (JP); Ayumi NOGUCHI, Kanagawa (JP); Makoto KANNO, Kanagawa (JP); Seigo SHINOZAKI, Kanagawa (JP)

(21) Appl. No.: 14/614,839

(22) Filed: Feb. 5, 2015

(30) Foreign Application Priority Data
Sep. 25, 2014 (JP) 2014-194943

(51) Int. Cl. G03G 15/08

(52) U.S. Cl. CPC G03G 15/0889; G03G 15/0865

(57) ABSTRACT

A powder container device includes a powder container that contains powder and has an opening at one end, the powder container being installed in a substantially horizontal orientation and having a projection on an inner peripheral surface of the powder container, the projection transporting the powder toward the opening when the powder container rotates; and a lid member that covers the opening and has an outlet through which the powder flows, the lid member being held in a non-rotatable manner. The powder container device does not have a structure for scooping the powder, which has been transported by the rotation of the powder container, toward a rotational axis, and discharges the powder through the outlet.

### CROSS-REFERENCE TO RELATED APPLICATIONS

This application is based on and claims priority under 35 USC 119 from Japanese Patent Application No. 2014-194943 filed Sep. 25, 2014.

### BACKGROUND

### Technical Field

The present invention relates to a powder container device.

### SUMMARY

According to an aspect of the invention, there is provided a powder container device including a powder container that contains powder and has an opening at one end, the powder container being installed in a substantially horizontal orientation and having a projection on an inner peripheral surface of the powder container, the projection transporting the powder toward the opening when the powder container rotates; and a lid member that covers the opening and has an outlet for the powder, the lid member being held in a non-rotatable manner. The powder container device does not have a structure for scooping the powder, which has been transported by the rotation of the powder container, toward a rotational axis, and discharges the powder through the outlet.

### BRIEF DESCRIPTION OF THE DRAWINGS

An exemplary embodiment of the present invention will be described in detail based on the following figures, wherein:

FIG. 1 is a perspective view of an image forming apparatus according to an exemplary embodiment of the present invention;

FIG. 2 is a schematic diagram illustrating the inner structure of the image forming apparatus illustrated in FIG. 1;

FIG. 3 is a perspective view of a toner cartridge according to the exemplary embodiment employed in the image forming apparatus illustrated in FIGS. 1 and 2;

FIG. 4 is an exploded perspective view of the toner cartridge illustrated in FIG. 3;

FIG. 5 is a side view of the toner cartridge illustrated in FIG. 3; and

FIG. 6 is a sectional view of a portion of the toner cartridge illustrated in FIG. 3 near a flange.

### DETAILED DESCRIPTION

An exemplary embodiment of the present invention will now be described.

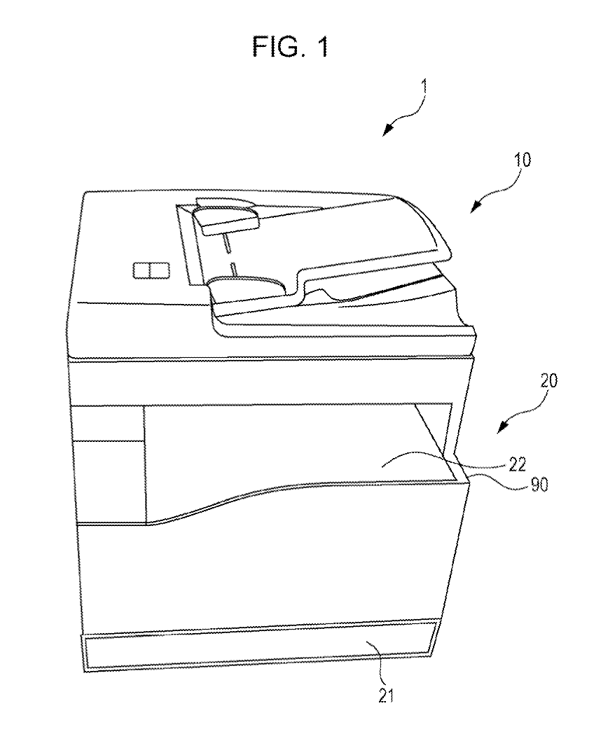

FIG. 1 is a perspective view of an image forming apparatus according to the exemplary embodiment of the present invention.

This image forming apparatus 1 includes a scanner 10 and a printer 20.

The scanner 10 is placed on an apparatus housing 90, which is a framework of the image forming apparatus 1. The printer 20 is disposed in the apparatus housing 90.

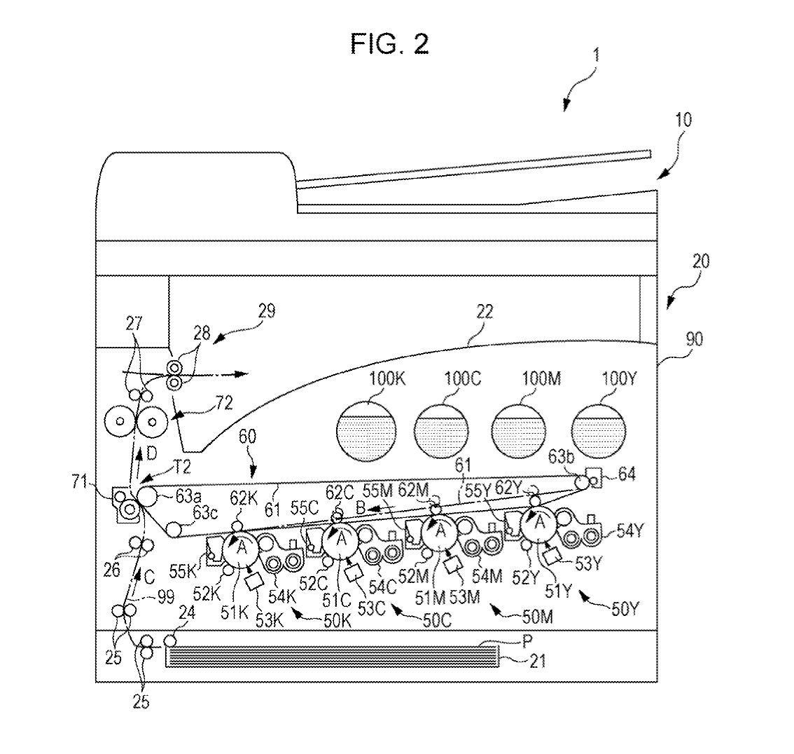

FIG. 2 is a schematic diagram illustrating the inner structure of the image forming apparatus 1 illustrated in FIG. 1.

The printer 20 includes four image forming units 50Y, 50M, 50C, and 50K, which are substantially horizontally arranged. The image forming units 50Y, 50M, 50C, and 50K form toner images of respective colors, which are yellow (Y), magenta (M), cyan (C), and black (K). In this specification, when common features of the image forming units 50Y, 50M, 50C, and 50K are described, the image forming units are referred to as image forming units 50 without attaching the symbols Y, M, C, and K for distinguishing the colors of the toners. This also applies to components other than the image forming units.

Each image forming unit 50 includes a photoconductor 51. An electrostatic latent image is formed on a surface of the photoconductor 51 and developed into a toner image while the photoconductor 51 receives a driving force and rotates in the direction shown by the arrow A.

A charging device 52, an exposure device 53, a developing device 54, a first transfer device 62, and a cleaner 55 are arranged around the photoconductor 51 included in each image forming unit 50. The first transfer device 62 is located such that an intermediate transfer belt 61, which will be described below, is interposed between the first transfer device 62 and the photoconductor 51. The first transfer device 62 is not a component of the image forming unit 50, but is a component of an intermediate transfer unit 60, which will be described below.

The charging device 52 uniformly charges the surface of the photoconductor 51.

The exposure device 53 forms an electrostatic latent image on the photoconductor 51 by irradiating the uniformly charged surface of the photoconductor 51 with exposure light that is modulated on the basis of an image signal.

The developing device 54 develops the electrostatic latent image on the photoconductor 51 with toner of the color corresponding to the image forming unit 50, thereby forming a toner image on the photoconductor 51.

The first transfer device 62 transfers the toner image formed on the photoconductor 51 onto the intermediate transfer belt 61, which will be described below.

The cleaner 55 removes from the photoconductor 51 the toner or the like that remains on the photoconductor 51 after the transferring process.

The intermediate transfer unit 60 is disposed above the four image forming units 50. The intermediate transfer unit 60 includes the intermediate transfer belt 61. The intermediate transfer belt 61 is supported by plural rollers including a drive roller 63a, a driven roller 63b, and a stretching roller 63c. The intermediate transfer belt 61 is driven by the drive roller 63a and circulates in the direction shown by the arrow B along a circulating path including paths on the four photoconductors 51 of the respective image forming units 50.

The toner images on the photoconductors 51 are successively transferred onto the intermediate transfer belt 61 in a superposed manner by operations of the respective first transfer devices 62. The toner images that have been transferred onto the intermediate transfer belt 61 are transported to a second transfer position T2 by the intermediate transfer belt 61. A second transfer device 71 is disposed at the second transfer position T2, and the toner images on the intermediate transfer belt 61 are transferred onto a paper sheet P, which has been transported to the second transfer position T2, by an operation of the second transfer device 71. Transportation of the paper sheet P will be described below. The toner or the like that remains on the intermediate transfer belt 61 after the toner images have been transferred onto the paper sheet P is removed from the intermediate transfer belt 61 by the cleaner 64.

Toner cartridges 100 containing toners of the respective colors are disposed above the intermediate transfer unit 60. When the toner contained in one of the developing devices 54 is consumed in the developing process, the toner is supplied to that developing device 54 through a toner supply channel (not shown) from the toner cartridge 100 containing the toner of the same color. The toner cartridges 100 are detachably attached to the apparatus housing 90. When the toner cartridges 100 become empty, they are removed and replaced with new toner cartridges 100.

A paper sheet P is fed from a paper tray 21 by a pick-up roller 24, and is transported to timing adjustment rollers 26 by transport rollers 25 along a transport path 99 in the direction shown by the arrow C. The paper sheet P that has been transported to the timing adjustment rollers 26 is transported by the timing adjustment rollers 26 toward the second transfer position T2 so that the paper sheet P reaches the second transfer position T2 at the time when the toner images on the intermediate transfer belt 61 reach the second transfer position T2. The paper sheet P transported by the timing adjustment rollers 26 receives the toner images from the intermediate transfer belt 61 at the second transfer position T2 as a result of the operation of the second transfer device 71. The paper sheet P to which the toner images have been transferred is further transported in the direction shown by the arrow D and passes through a fixing device 72. The toner images on the paper sheet P are fixed to the paper sheet P by being heated and pressurized by the fixing device 72. Thus, an image formed of the fixed toner images is printed on the paper sheet P. The paper sheet, to which the toner images are fixed by the fixing device 72, is further transported by transport rollers 27 and is ejected by paper output rollers 28 to a paper output tray 22 through a paper output slot 29.

Next, the structure of each toner cartridge 100 will be described.

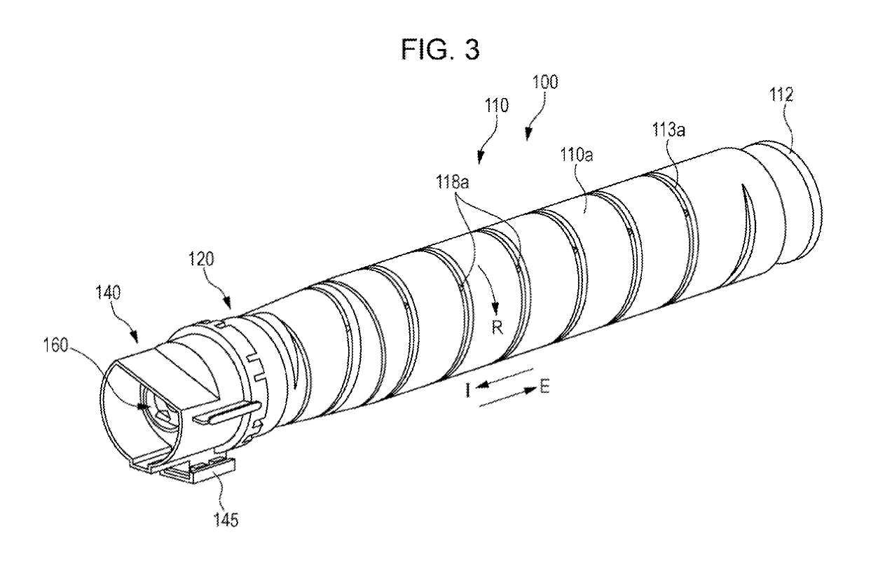

FIG. 3 is a perspective view of each toner cartridges 100 according to the exemplary embodiment employed in the image forming apparatus illustrated in FIGS. 1 and 2.

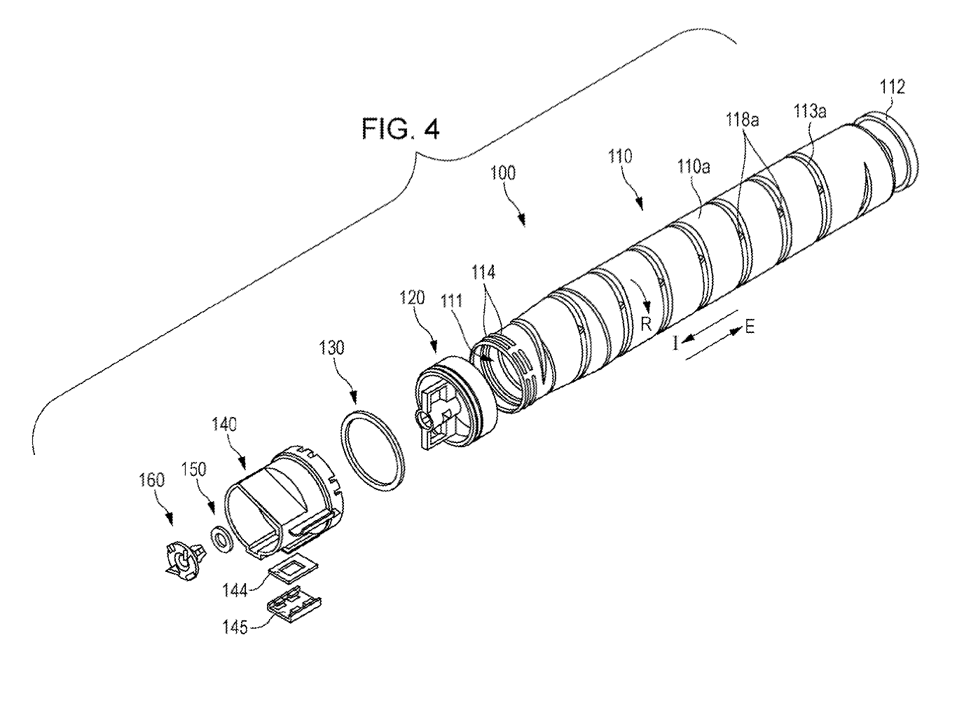

FIG. 4 is an exploded perspective view of the toner cartridge 100 illustrated in FIG. 3.

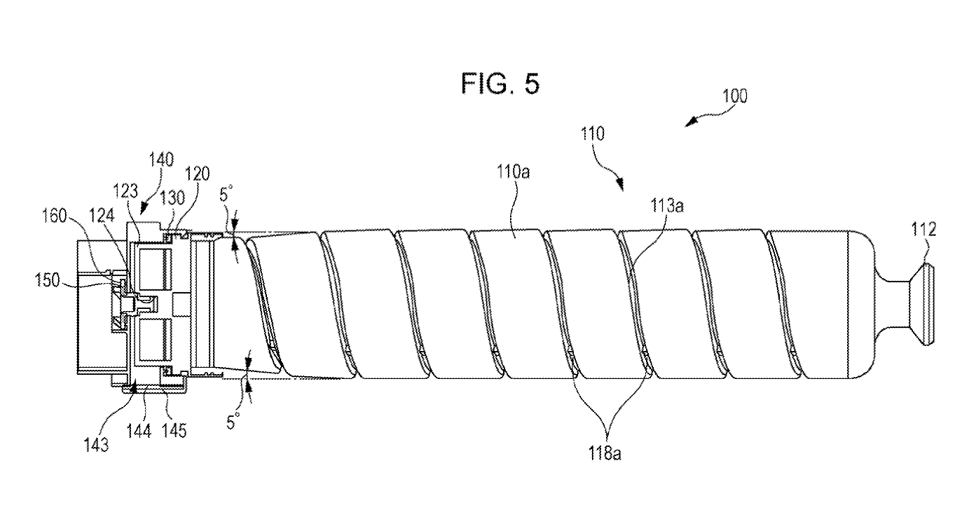

FIG. 5 is a side view of the toner cartridge 100 illustrated in FIG. 3. In FIG. 5, a portion of the toner cartridge 100 excluding a toner bottle 110 is illustrated in cross section.

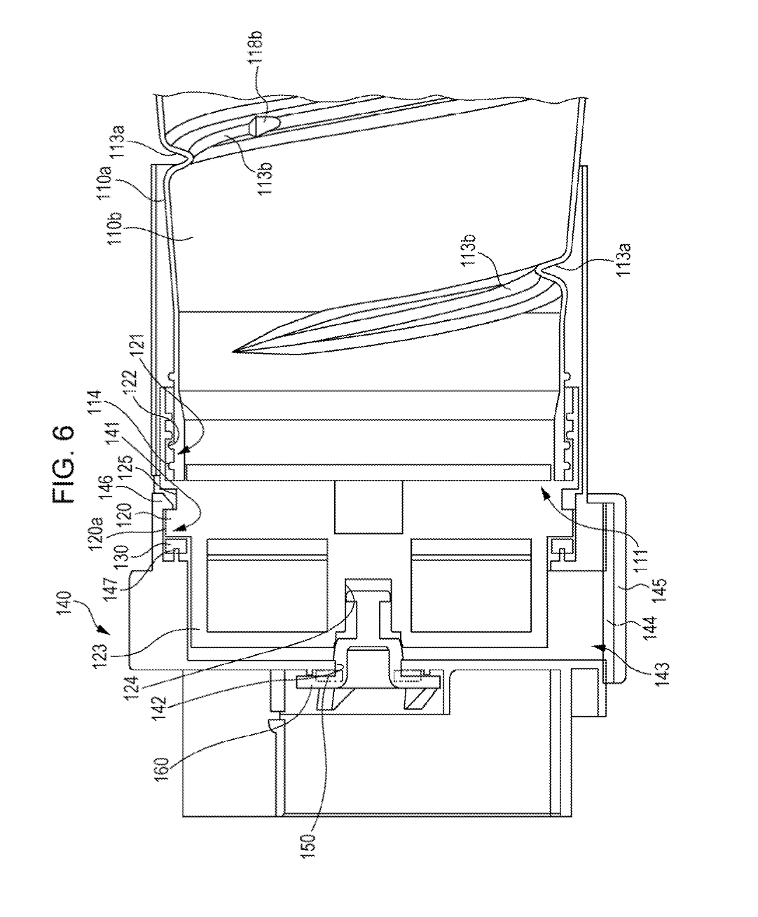

FIG. 6 is a sectional view of a portion of the toner cartridge 100 illustrated in FIG. 3 near a flange 140.

As illustrated in FIG. 4, the toner cartridge 100 includes the toner bottle 110, an agitating member 120, a sealing member 130, the flange 140, another sealing member 150, and a coupling 160. The toner cartridge 100 corresponds to an example of a powder container device according to an exemplary embodiment of the present invention. The toner bottle 110 corresponds to an example of a powder container. The agitating member 120 corresponds to an example of an agitating member, and the coupling 160 corresponds to an example of a driving-force receiving portion of the agitating member. The flange 140 corresponds to an example of a lid member.

The toner cartridge 100, in which toner is contained in the toner bottle 110, is assembled as illustrated in FIG. 3. The toner cartridge 100 in the assembled state is inserted into the image forming apparatus 1 illustrated in FIGS. 1 and 2 and installed in a horizontal or substantially horizontal orientation. When the toner bottle 110 becomes empty, the toner cartridge 100 is pulled out in the direction shown by the arrow E, and a new toner cartridge 100 is inserted.

The toner bottle 110 has a substantially cylindrical shape, and has an opening 111 at one end thereof. The toner bottle 110 contains the toner. A handle 112 to be gripped when the toner cartridge 100 is pulled out from the image forming apparatus 1 is provided at the other end of the toner bottle 110. A groove 113a that extends in a helical manner is formed in an outer peripheral surface 110a of the toner bottle 110. The helical groove 113a extends intermittently since reinforcing ribs 118a are provided therein. Thus, a single groove 113a, which extends intermittently in a helical manner, is formed in the outer peripheral surface 110a of the toner bottle 110.

The bottom surface of the groove 113a projects from an inner peripheral surface 110b of the toner bottle 110. In other words, a single projection 113b (see FIG. 6) that extends in a helical manner is formed on the inner peripheral surface 110b of the toner bottle 110. The projection 113b is interrupted by bottom surfaces 118b of the reinforcing ribs 118a provided on the outer peripheral surface 110a, and extends intermittently. As described below, the toner bottle 110 rotates in the direction shown by the arrow R illustrated in FIGS. 3 and 4. The toner bottle 110 is filled with the toner (not shown). When the toner bottle 110 rotates, the toner is transported toward the opening 111 by the helical projection 113b on the inner peripheral surface 110b.

In the present exemplary embodiment, the toner contained in the toner bottle 110 has an angle of repose that is greater than or equal to 35 degrees, typically about 40 degrees, and has low fluidity. As illustrated in FIG. 5, in the present exemplary embodiment, a portion of the toner bottle 110 near the opening 111 is tapered toward the opening 111 at an inclination angle of about 5 degrees with respect to a rotational axis. It has been confirmed that, when the inclination angle is smaller than or equal to 12 degrees or approximately 12 degrees, the toner may be smoothly transported toward the opening 111 by the projection 113b on the inner peripheral surface 110b even when the toner has an angle of repose of about 40 degrees.

An external thread 114 is formed on the outer peripheral surface 110a of the toner bottle 110 in a region near the opening 111. The external thread 114 is engaged with an internal thread 122 (see FIG. 6) formed on the agitating member 120, so that the agitating member 120 is fixed to the toner bottle 110. Thus, the toner bottle 110 and the agitating member 120 rotate together.

The agitating member 120 includes a cylindrical portion 121 that is open at a side adjacent to the toner bottle 110, and the internal thread 122 is formed on the inner peripheral surface of the cylindrical portion 121. The agitating member 120 also includes an agitating blade 123, which projects toward the flange 140. As illustrated in FIG. 6, the flange 140 also includes a hollow cylindrical portion 141 that is open at a side facing the toner bottle 110. The agitating blade 123 of the agitating member 120 is disposed in the cylindrical portion 141 of the flange 140. The agitating blade 123 has a function of agitating the toner that has been transported into the flange 140 through the opening 111 of the toner bottle 110. The toner is agitated around the rotational axis in the direction shown by the arrow R, and is thereby prevented from aggregating. A fitting hole 124 is formed at an end of the agitating blade 123. A through hole 142 is formed in the flange 140 at a position facing the fitting hole 124. The coupling 160 is inserted through the through hole 142 from the outside of the flange 140 (from the left side in FIG. 6) and fitted to the fitting hole 124. When the toner cartridge 100 is inserted into the image forming apparatus 1 (see FIGS. 1 and 2), the coupling 160 engages with a coupling (not shown) disposed in the apparatus body. The coupling 160 is rotated by a motor (not shown) disposed in the apparatus body through the coupling disposed in the apparatus body. The coupling 160 is fitted to the fitting hole 124 in the agitating member 120. Therefore, when the coupling 160 is rotated, the agitating member 120 is also rotated together. In addition, since the agitating member 120 is fixed to the toner bottle 110, when the agitating member 120 is rotated, the toner bottle 110 is also rotated together.

The agitating member 120 has a retaining groove 125 in an outer peripheral surface 120a thereof, the retaining groove 125 extending along the circumference of the agitating member 120. Retaining lugs 146, which are fitted to the retaining groove 125, are provided on the flange 140. The retaining lugs 146 fix the flange 140 to the agitating member 120 in a rotational axis direction (horizontal direction in FIG. 6), but slide along the retaining groove 125 in the rotational direction (direction shown by the arrow R in FIGS. 3 and 4). When the toner cartridge 100 is inserted into the image forming apparatus 1, the flange 140 is fixed to the apparatus body in a non-rotatable manner. Therefore, the agitating member 120 rotates while sliding along the retaining lugs 146 of the flange 140.

The ring-shaped sealing member 130 is clamped between the agitating member 120 and the flange 140, and is pressed by a circular projection 147 provided on the flange 140. The sealing member 130 prevents the toner from leaking through a gap between the agitating member 120 and the flange 140. The other ring-shaped sealing member 150 is located so as to surround the through hole 142 in the flange 140, and prevents the toner from leaking through the through hole in the flange 140.

The flange 140 serves as a lid for the toner bottle 110, and has an outlet 143 through which the toner is discharged. A region around the outlet 143 is covered with another sealing member 144. The outlet 143 and the sealing member 144 are covered with a shutter 145. The shutter 145 is opened when the toner cartridge 100 is inserted into the image forming apparatus 1, and is closed when the toner cartridge 100 is pulled out of the image forming apparatus 1. As described above, when the toner cartridge 100 is inserted into the image forming apparatus 1, the shutter 145 is opened and the flange 140 is retained in a non-rotatable manner. In addition, the coupling (not shown) disposed in the apparatus body and the coupling 160 included in the toner cartridge 100 engage with each other. The coupling 160 is rotated by the motor disposed in the apparatus body through the coupling disposed in the apparatus body. As a result of the rotation of the coupling 160, the agitating member 120 and the toner bottle 110 included in the toner cartridge 100 are rotated. The toner contained in the toner bottle 110 is transported toward the opening 111 by the rotation of the toner bottle 110, and is transported into the flange 140 through the opening 111. The toner that has entered the flange 140 is discharged to the outside of the agitating member 120 through the outlet 143 while being agitated by the agitating blade 123 of the agitating member 120.

The toner cartridge 100 described in the present exemplary embodiment is a representative of the toner cartridges 100Y, 100M, 100C, and 100K illustrated in FIG. 2. In other words, the toner discharged from the toner cartridge 100 is supplied to the corresponding developing device 54 and used to form a toner image.

Here, the toner cartridge 100 according to the present exemplary embodiment is rotated by the coupling 160, which is provided on the rotational axis. Therefore, compared to the structure in which a gear formed on the toner bottle 110 is driven, the structure of the driving system for rotating the toner cartridge is simplified. In addition, the four toner cartridges 100Y, 100M, 1000, and 100K illustrated in FIG. 2 may be arranged without leaving spaces for accommodating gears therebetween (see FIG. 3), and space may be saved.

In addition, in the toner cartridge 100 according to the present exemplary embodiment, although the toner bottle 110 is tapered toward the opening 111 at an angle of about 5 degrees, there is no other opening that is acutely tapered in the rotational axis direction as in Japanese Unexamined Patent Application Publication Nos. 2004-280064 and 2010-210946. Therefore, it is not necessary to provide a structure (shape, member, etc.) for scooping the toner to the opening. Thus, the toner cartridge 100 is suitable as a cartridge that contains and discharges toner that has low fluidity.

In the present exemplary embodiment, a single projection 113b that transports the toner is formed on the inner peripheral surface 110b of the toner bottle 110 so as to extend intermittently. However, the number of projections 113b that transport the toner is not limited to 1, and plural short projections may be discretely arranged.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A powder container device comprising:
a powder container that contains powder and has an opening at one end, the powder container being installed in a substantially horizontal orientation and having a projection on an inner peripheral surface of the powder container, the projection transporting the powder toward the opening when the powder container rotates; and
a lid member that covers the opening and has an outlet through which the powder flows, the lid member being held in a non-rotatable manner,
wherein the powder container device does not have a structure for scooping the powder, which has been transported by the rotation of the powder container, toward a rotational axis, and discharges the powder through the outlet.

2. The powder container device according to claim 1, wherein the projection extends intermittently or continuously in a helical manner.

3. The powder container device according to claim 1, wherein the lid member includes a hollow cylindrical portion that is open at a side facing the powder container, and
wherein the powder container device further comprises an agitating member that is disposed in the cylindrical portion and fixed to the powder container, the agitating member rotating together with the powder container around the rotational axis.

4. The powder container device according to claim 2, wherein the lid member includes a hollow cylindrical portion that is open at a side facing the powder container, and
wherein the powder container device further comprises an agitating member that is disposed in the cylindrical portion and fixed to the powder container, the agitating member rotating together with the powder container around the rotational axis.

5. The powder container device according to claim 3, wherein the agitating member includes a driving-force receiving portion that extends through the lid member in a rotational axis direction, and transmits rotational driving force received by the driving-force receiving portion to the powder container.

6. The powder container device according to claim 4, wherein the agitating member includes a driving-force receiving portion that extends through the lid member in a rotational axis direction, and transmits rotational driving force received by the driving-force receiving portion to the powder container.

7. A powder container device comprising:
a powder container that contains powder and has an opening at one end, the powder container being installed in a substantially horizontal orientation and having a projection on an inner peripheral surface of the powder container, the projection transporting the powder toward the opening when the powder container rotates; and
a lid member that covers the opening and has an outlet through which the powder flows, the lid member being held in a non-rotatable manner,
wherein the powder container includes a portion that is tapered toward the one end at an inclination of approximately 12 degrees or less with respect to a rotational axis, and the opening at the one end has a diameter smaller than a diameter of a portion of the powder container separated from the one end.
